(19) United States
(12) Patent Application Publication
(10) Pub. No.: US 2026/0323604 A1
(43) Pub. Date: Oct. 15, 2026

(54) SIGNAL TRANSMISSION METHOD AND APPARATUS

(71) Applicant: HUAWEI TECHNOLOGIES CO., LTD., Shenzhen (CN)

(72) Inventors: Qianli Ma, Chengdu (CN); Huang Huang, Chengdu (CN); Shan Wen, Chengdu (CN)

(73) Assignee: HUAWEI TECHNOLOGIES CO., LTD., Shenzhen (CN)

(21) Appl. No.: 19/690,319

(22) Filed: May 28, 2026

Related U.S. Application Data
(63) Continuation of application No. PCT/CN2024/133630, filed on Nov. 21, 2024.

(30) Foreign Application Priority Data
Nov. 29, 2023 (CN) 202311614343.2

(51) Int. Cl. H04W 72/044; H04W 56/00

(52) U.S. Cl. CPC H04W 72/044; H04W 56/002

(57) ABSTRACT

This application discloses a signal transmission method and an apparatus. The method includes: performing transform precoding on a PBCH time domain signal to obtain a PBCH frequency domain signal; generating at least one frequency domain signal, where each of the at least one frequency domain signal is generated based on a Golay complementary sequence (GCS); generating an SSB based on the at least one frequency domain signal and the PBCH frequency domain signal, where the at least one frequency domain signal and the PBCH frequency domain signal occupy different symbols; and outputting the SSB. In the method, the at least one frequency domain signal in the SSB is generated based on the Golay complementary sequence, so that a PAPR of the at least one frequency domain signal in the SSB can be improved, and system performance can be improved.

### CROSS-REFERENCE TO RELATED APPLICATIONS

This application is a continuation of International Application No. PCT/CN2024/133630, filed on Nov. 21, 2024, which claims priority to Chinese Patent Application No. 202311614343.2, filed on Nov. 29, 2023. The disclosures of the aforementioned applications are hereby incorporated by reference in their entireties.

### TECHNICAL FIELD

This application relates to the field of communication technologies, and in particular, to a signal transmission method and an apparatus.

### BACKGROUND

A synchronization signal block (SSB) includes a primary synchronization signal (PSS), a secondary synchronization signal (SSS), and a physical broadcast channel (PBCH) signal. In 5th generation (5G) communication systems, a peak to average power ratio (PAPRs) of the PSS and SSS is lower than that of the PBCH signal, so no performance loss is caused.

However, with evolution of communication systems, for example, in 6th generation (6G) communication systems, frequency bands used for downlink transmission may be different. When a PBCH signal is transmitted by using a single downlink carrier, the PAPR of the PSS and SSS is higher than that of the PBCH signal. Consequently, power backoff of the system increases, and performance loss is caused.

### SUMMARY

This application provides a signal transmission method and an apparatus, to improve a PAPR of at least one frequency domain signal (such as a PSS or an SSS) in an SSB, and improve system performance.

According to a first aspect, a signal transmission method is provided. The method may be performed by a first communication device. Unless otherwise specified, the “first communication device” in this application may be the first communication device (for example, a network device or a terminal device), or may be a component (for example, a processor, a chip, or a chip system) in the first communication device, or may be a logical module or software that can implement all or a part of functions of the first communication device. The method includes: performing transform precoding on a PBCH time domain signal to obtain a PBCH frequency domain signal; generating at least one frequency domain signal, where each of the at least one frequency domain signal is generated based on a Golay complementary sequence (GCS); generating an SSB based on the at least one frequency domain signal and the PBCH frequency domain signal, where the at least one frequency domain signal and the PBCH frequency domain signal occupy different symbols; and outputting the SSB.

In the foregoing solution, the at least one frequency domain signal (such as a PSS or an SSS) in the SSB is generated based on the Golay complementary sequence, so that a PAPR of the at least one frequency domain signal in the SSB can be improved. For example, the PAPR of the at least one frequency domain signal in the SSB is lower than a PAPR of a PBCH signal in the SSB. In this way, system performance is improved.

In a possible design, the at least one frequency domain signal includes a PSS and/or an SSS. In other words, in the SSB, only the PSS may be generated based on the Golay complementary sequence, or only the SSS may be generated based on the Golay complementary sequence, or both the PSS and the SSS are generated based on the Golay complementary sequence.

In a possible design, the generating the at least one frequency domain signal may include: determining a first Golay complementary sequence based on cell identification information; and generating a first frequency domain signal based on the first Golay complementary sequence, where the at least one frequency domain signal includes the first frequency domain signal, the cell identification information is related to a type of the first frequency domain signal, and the type of the first frequency domain signal is PSS or SSS.

In this way, the cell identification information can be carried in generation information of the Golay complementary sequence, to ensure original performance of the PSS and/or the SSS (that is, carrying the cell identification information).

In a possible design, the determining the first Golay complementary sequence based on cell identification information may include: determining a first parameter based on the cell identification information; and determining the first Golay complementary sequence based on the first parameter, where the first Golay complementary sequence is a function of the first parameter.

For example, if the cell identification information is a second cell identifier Cell_ID(2), and the type of the first frequency domain signal is PSS,
the first parameter and the second cell identifier Cell_ID(2) satisfy the following relationship:

cᵢₙᵢₜ=c1*Cell_ID(2).

c_init represents the first parameter, c1 is related to a quantity of candidate values of cell identifiers Cell_ID and a quantity of candidate values of the second cell identifier Cell_ID(2), and the cell identifiers include the second cell identifier Cell_ID(2) and a first cell identifier Cell_ID(1).

For example, if the cell identification information is the first cell identifier Cell_ID(1), and the type of the first frequency domain signal is SSS, the first parameter and the first cell identifier Cell_ID(1) satisfy the following relationship:

c_init=Cell_ID(1)mod c2.

c_init represents the first parameter, and c2 is a quantity of candidate values of the first cell identifier Cell_ID(1).

For example, if the cell identification information includes the first cell identifier Cell_ID(1) and the second cell identifier Cell_ID(2), and the type of the first frequency domain signal is SSS,
the first parameter, the first cell identifier Cell_ID(1), and the second cell identifier Cell_ID(2) satisfy the following relationship:

c_init=c3*└Cell_ID(1)/c2┘+c4*Cell_ID(2).

c_init represents the first parameter, c2 is a quantity of candidate values of the first cell identifier Cell_ID(1), c3 is a sequence interval step 1 of the SSS, and c4 is a sequence interval step 2 of the SSS.

Certainly, the foregoing several cases are merely examples, and an actual relationship between the cell identification information and the first parameter is not limited to the foregoing several relationships.

In a possible design, the generating the at least one frequency domain signal may include: performing a cyclic shift on a second Golay complementary sequence based on the cell identification information; and generating a second frequency domain signal based on a second Golay complementary sequence obtained through the cyclic shift, where the at least one frequency domain signal includes the second frequency domain signal.

In this way, the cell identification information can be indicated by performing the cyclic shift on the Golay complementary sequence, to ensure original performance of the PSS and/or the SSS (that is, carrying the cell identification information).

In a possible design, the cell identification information is a second cell identifier Cell_ID(2), and the second frequency domain signal is a PSS; or the cell identification information is a first cell identifier Cell_ID(1), and the second frequency domain signal is an SSS; or the cell identification information includes the first cell identifier Cell_ID(1) and the second cell identifier Cell_ID(2), and the second frequency domain signal is an SSS.

Certainly, the foregoing several cases are merely examples, and an actual application is not limited thereto.

In a possible design, the at least one frequency domain signal and the PBCH frequency domain signal are mapped to a same frequency domain resource.

In this way, the at least one frequency domain signal can be used as a primary pilot (for example, a DMRS) of a PBCH signal. For example, a PSS and/or an SSS may be used to perform channel estimation on the PBCH signal, so that pilot overheads of the PBCH signal can be reduced. In addition, the Golay complementary sequence has both a low PAPR and frequency domain flatness. This further helps improve channel estimation quality of the PBCH signal.

In a possible design, the generating the at least one frequency domain signal may include: extending a third Golay complementary sequence to obtain a third frequency domain signal, where the at least one frequency domain signal includes the third frequency domain signal, and a length to which the third Golay complementary sequence is extended is related to a length of the PBCH frequency domain signal.

In this way, the at least one frequency domain signal generated based on the Golay complementary sequence and the PBCH frequency domain signal can have a same length (or occupy a same frequency domain bandwidth), to further ensure accuracy of channel estimation on a PBCH signal based on the at least one frequency domain signal.

According to a second aspect, a signal transmission method is provided. The method may be performed by a second communication device. Unless otherwise specified, the “second communication device” in this application may be the second communication device (for example, a terminal device or a network device), or may be a component (for example, a processor, a chip, or a chip system) in the second communication device, or may be a logical module or software that can implement all or a part of functions of the second communication device. The method includes: receiving an SSB, where the SSB includes at least one frequency domain signal and a PBCH frequency domain signal, and each of the at least one frequency domain signal is generated based on a Golay complementary sequence; and performing downlink synchronization based on the SSB.

In the foregoing solution, because the at least one frequency domain signal in the SSB received by the second communication device is generated based on a Golay complementary sequence, a PAPR of the at least one frequency domain signal in the SSB is improved. For example, the PAPR of the at least one frequency domain signal in the SSB is lower than a PAPR of a PBCH signal in the SSB. In this way, system performance is improved.

In a possible design, the at least one frequency domain signal includes a PSS and/or an SSS.

In a possible design, the performing downlink synchronization based on the SSB may include: determining P Golay complementary sequences based on P candidate values of a second cell identifier Cell_ID(2), where P is a positive integer; performing a peak search on the PSS in the SSB based on the P Golay complementary sequences; and determining timing information and frequency offset information of the PSS based on a found maximum peak value, performing synchronization processing on the PSS based on the timing information and the frequency offset information of the PSS, and determining the second cell identifier Cell_ID(2) based on a Golay complementary sequence corresponding to the found maximum peak value.

In this way, it can be ensured that the PSS is correctly detected, and downlink synchronization on the PSS is completed.

In a possible design, the performing downlink synchronization based on the SSB may further include: performing a first time of synchronization processing on the SSS in the SSB based on the timing information and the frequency offset information of the PSS; determining Q Golay complementary sequences based on Q candidate values of a first cell identifier Cell_ID(1), where Q is a positive integer, and performing, based on the Q Golay complementary sequences, a peak search on an SSS obtained through the first time of synchronization processing; and determining timing information and frequency offset information of the SSS based on a found maximum peak value, performing a second time of synchronization processing on the SSS based on the timing information and the frequency offset information of the SSS, and determining the first cell identifier Cell_ID(1) based on a Golay complementary sequence corresponding to the found maximum peak value.

In this way, it can be ensured that the SSS is correctly detected, and downlink synchronization on the SSS is completed.

In a possible design, the at least one frequency domain signal and the PBCH frequency domain signal are mapped to a same frequency domain resource.

In this way, the at least one frequency domain signal can be used as a primary pilot (for example, a DMRS) of a PBCH signal. For example, a PSS and/or an SSS may be used to perform channel estimation on the PBCH signal.

In a possible design, channel estimation may be further performed on the PBCH frequency domain signal based on the at least one frequency domain signal.

In this way, pilot overheads of the PBCH signal can be reduced. In addition, the Golay complementary sequence has both a low PAPR and frequency domain flatness. This further helps improve channel estimation quality.

According to a third aspect, a communication apparatus is provided. The apparatus includes a module, a unit, or a technical means configured to implement the method according to any one of the first aspect or the possible designs of the first aspect.

For example, the apparatus may include:
a processing module, configured to: perform transform precoding on a PBCH time domain signal to obtain a PBCH frequency domain signal; generate at least one frequency domain signal, where each of the at least one frequency domain signal is generated based on a Golay complementary sequence; and generate an SSB based on the at least one frequency domain signal and the PBCH frequency domain signal, where the at least one frequency domain signal and the PBCH frequency domain signal occupy different symbols; and
a transceiver module, configured to output the SSB.

In a possible design, the at least one frequency domain signal includes a PSS and/or an SSS.

In a possible design, the processing module may be configured to: determine a first Golay complementary sequence based on cell identification information; and generate a first frequency domain signal based on the first Golay complementary sequence, where the at least one frequency domain signal includes the first frequency domain signal, the cell identification information is related to a type of the first frequency domain signal, and the type of the first frequency domain signal is PSS or SSS.

In a possible design, the processing module may be configured to: determine a first parameter based on the cell identification information; and determine a first Golay complementary sequence based on the first parameter, where the first Golay complementary sequence is a function of the first parameter.

In a possible design, if the cell identification information is a second cell identifier Cell_ID(2), and the type of the first frequency domain signal is PSS,
the first parameter and the second cell identifier Cell_ID(2) satisfy the following relationship:

c_init=c1*Cell_ID(2).

c_init represents the first parameter, c1 is related to a quantity of candidate values of cell identifiers Cell_ID and a quantity of candidate values of the second cell identifier Cell_ID(2), and the cell identifiers include the second cell identifier Cell_ID(2) and a first cell identifier Cell_ID(1).

In a possible design, if the cell identification information is the first cell identifier Cell_ID(1), and the type of the first frequency domain signal is SSS,
the first parameter and the first cell identifier Cell_ID(1) satisfy the following relationship:

c_init=Cell_ID(1)mod c2.

c_init represents the first parameter, and c2 is a quantity of candidate values of the first cell identifier Cell_ID(1).

In a possible design, if the cell identification information includes the first cell identifier Cell_ID(1) and the second cell identifier Cell_ID(2), and the type of the first frequency domain signal is SSS,
the first parameter, the first cell identifier Cell_ID(1), and the second cell identifier Cell_ID(2) satisfy the following relationship:

c_init=c3*└Cell_ID(1)/c2┘+c4*Cell_ID(2).

c_init represents the first parameter, c2 is a quantity of candidate values of the first cell identifier Cell_ID(1), c3 is a sequence interval step 1 of the SSS, and c4 is a sequence interval step 2 of the SSS.

In a possible design, the processing module may be configured to: perform a cyclic shift on a second Golay complementary sequence based on the cell identification information; and generate a second frequency domain signal based on a second Golay complementary sequence obtained through the cyclic shift, where the at least one frequency domain signal includes the second frequency domain signal.

In a possible design, the cell identification information is a second cell identifier Cell_ID(2), and the second frequency domain signal is a PSS; or the cell identification information is a first cell identifier Cell_ID(1), and the second frequency domain signal is an SSS; or the cell identification information includes the first cell identifier Cell_ID(1) and the second cell identifier Cell_ID(2), and the second frequency domain signal is an SSS.

In a possible design, the at least one frequency domain signal and the PBCH frequency domain signal are mapped to a same frequency domain resource.

In a possible design, the processing module may be configured to extend a third Golay complementary sequence to obtain a third frequency domain signal, where the at least one frequency domain signal includes the third frequency domain signal, and a length to which the third Golay complementary sequence is extended is related to a length of the PBCH frequency domain signal.

According to a fourth aspect, a communication apparatus is provided. The apparatus includes a module, a unit, or a technical means configured to implement the method according to any one of the second aspect or the possible designs of the second aspect.

For example, the apparatus may include:
a transceiver module, configured to receive an SSB, where the SSB includes at least one frequency domain signal and a PBCH frequency domain signal, and each of the at least one frequency domain signal is generated based on a Golay complementary sequence; and
a processing module, configured to perform downlink synchronization based on the SSB.

In a possible design, the at least one frequency domain signal includes a PSS and/or an SSS.

In a possible design, the processing module may be configured to: determine P Golay complementary sequences based on P candidate values of a second cell identifier Cell_ID(2), where P is a positive integer; perform a peak search on the PSS in the SSB based on the P Golay complementary sequences; and determine timing information and frequency offset information of the PSS based on a found maximum peak value, perform synchronization processing on the PSS based on the timing information and the frequency offset information of the PSS, and determine the second cell identifier Cell_ID(2) based on a Golay complementary sequence corresponding to the found maximum peak value.

In a possible design, the processing module may further be configured to: perform a first time of synchronization processing on the SSS in the SSB based on the timing information and the frequency offset information of the PSS; determine Q Golay complementary sequences based on Q candidate values of a first cell identifier Cell_ID(1), where Q is a positive integer, and perform, based on the Q Golay complementary sequences, a peak search on an SSS obtained through the first time of synchronization processing; and determine timing information and frequency offset information of the SSS based on a found maximum peak value, perform a second time of synchronization processing on the SSS based on the timing information and the frequency offset information of the SSS, and determine the first cell identifier Cell_ID(1) based on a Golay complementary sequence corresponding to the found maximum peak value.

In a possible design, the at least one frequency domain signal and the PBCH frequency domain signal are mapped to a same frequency domain resource.

In a possible design, the processing module may be further configured to perform channel estimation on the PBCH frequency domain signal based on the at least one frequency domain signal.

According to a fifth aspect, a communication apparatus is provided. The apparatus includes a processor and an interface circuit, the interface circuit is electrically coupled to the processor, and the processor performs, by using a logic circuit or by executing code instructions, the method according to any one of the first aspect or the possible designs of the first aspect or the method according to any one of the second aspect or the possible designs of the second aspect.

According to a sixth aspect, a computer-readable storage medium is provided. The storage medium stores a computer program or instructions, and when the computer program or the instructions are run, the method according to any one of the first aspect or the possible designs of the first aspect is performed, or the method according to any one of the second aspect or the possible designs of the second aspect is performed.

According to a seventh aspect, a computer program product is provided, including instructions. When the instructions are run on a computer, the method according to any one of the first aspect or the possible designs of the first aspect is performed, or the method according to any one of the second aspect or the possible designs of the second aspect is performed.

According to an eighth aspect, a communication system is provided, including a first communication apparatus and a second communication apparatus. The first communication apparatus is configured to perform the method according to any one of the first aspect or the possible designs of the first aspect, and the second communication apparatus is configured to perform the method according to any one of the second aspect or the possible designs of the second aspect.

For specific designs and beneficial effects of the third aspect to the eighth aspect, refer to corresponding designs and beneficial effects of the first aspect and the second aspect.

### BRIEF DESCRIPTION OF DRAWINGS

FIG. 1 is a flowchart of processing a DFT-s-OFDM signal;

FIG. 2 is a diagram of a frame structure of an SSB;

FIG. 3 is a comparison diagram of PAPRs of an m-sequence and a PBCH signal;

FIG. 4 is a diagram of a communication system to which an embodiment of this application is applicable;

FIG. 5 is a flowchart of a signal transmission method according to an embodiment of this application;

FIG. 6 is a diagram of a possible frame structure of an SSB according to an embodiment of this application;

FIG. 7 is a diagram of performing a cyclic shift on a Golay complementary sequence;

FIG. 8 is a diagram of a set of experimental data according to an embodiment of this application;

FIG. 9 is a flowchart of another signal transmission method according to an embodiment of this application;

FIG. 10 is a diagram of a structure of a communication apparatus according to an embodiment of this application; and

FIG. 11 is a diagram of a structure of another communication apparatus according to an embodiment of this application.

### DESCRIPTION OF EMBODIMENTS

For ease of understanding of the technical solutions provided in embodiments of this application, the following explains and describes technical terms used in embodiments of this application.
(1) “A plurality of” in embodiments of this application means two or more. The term “and/or” describes an association relationship for describing associated objects and represents that three relationships may exist. For example, A and/or B may represent the following three cases: Only A exists, both A and B exist, and only B exists. The character “/” generally indicates an “or” relationship between the associated objects. In addition, it should be understood that although the terms such as first and second may be used in embodiments of the present invention to describe objects, these objects are not limited by these terms. The terms are merely used for distinguishing the objects from each other.

Terms “including”, “having”, and any other variant thereof mentioned in descriptions of embodiments of this application are intended to cover a non-exclusive inclusion. For example, a process, a method, a system, a product, or a device that includes a series of steps or units is not limited to the listed steps or units, but optionally further includes other unlisted steps or units, or optionally further includes another inherent step or unit of the process, the method, the product, or the device. It should be noted that, in embodiments of this application, the terms such as “example” or “for example” are used to represent giving an example, an illustration, or a description. Any embodiment or design scheme described as an “example” or “for example” in embodiments of this application should not be explained as being more preferred or having more advantages than another embodiment or design scheme. Exactly, use of the term such as “example” or “for example” is intended to present a related concept in a specific manner.
(2) Single-carrier and multi-carrier

“Single-carrier” refers to convolving serially arranged transmit signals with a roll-off filter to form transmit signals. “Multi-carrier” refers to arranging transmit signals in parallel to form transmit signals through inverse fast fourier transform (IFFT).

For example, a single-carrier waveform may be a single carrier-quadrature amplitude modulation (SC-QAM) waveform, and a multi-carrier waveform may be an orthogonal frequency division multiplexing (OFDM) waveform. In addition, a discrete fourier transform-spread-orthogonal frequency division multiplexing (DFT-s-OFDM) waveform is almost equivalent to a conventional single-carrier waveform. However, the discrete fourier transform-spread-orthogonal frequency division multiplexing waveform is implemented in a multi-carrier manner, and therefore is easy to be compatible with OFDM. In essence, the discrete fourier transform-spread-orthogonal frequency division multiplexing waveform is still a single-carrier waveform, and therefore may also be considered as a single-carrier waveform.

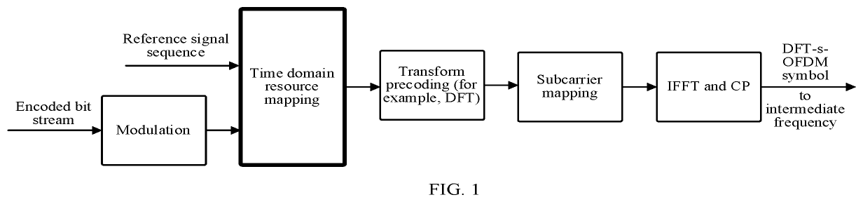

FIG. 1 is a flowchart of signal processing of a transmitter of a network device or a terminal device when a DFT-s-OFDM waveform is used for communication between network device and the terminal device.

As shown in FIG. 1, the transmitter modulates an encoded bit stream to obtain a modulated data sequence. The transmitter performs time domain resource mapping on a reference signal sequence and the modulated sequence (in other words, the transmitter determines time domain resources for the sequences, for example, determines OFDM symbols carrying the sequences). The reference signal sequence is, for example, at least one of a demodulation reference signal (DMRS) sequence, a phase tracking reference signal (PTRS) sequence, a tracking reference signal (TRS) sequence, or a channel state information-reference signal (CSI-RS) sequence. Transform precoding (for example, a discrete fourier transform (DFT) operation) is performed on a sequence obtained through the time domain resource mapping, to transform the sequence to a frequency domain. Subcarrier mapping is performed on a sequence obtained through the DFT (for example, the sequence is mapped to a resource element (RE)). IFFT is performed on a sequence obtained through the subcarrier mapping, and a cyclic prefix (CP) is added to obtain a DFT-s-OFDM sequence.

A receiver performs a process opposite to that of the transmitter. For example, after obtaining the DFT-s-OFDM sequence, the receiver removes the added CP from the sequence, and performs operations such as DFT, subcarrier demapping, and IDFT, to restore the reference signal sequence, the encoded bit stream, and the like.

It may be understood that the related operations in FIG. 1 are merely used as an example. Optionally, another possible operation, for example, at least one of frequency domain spectrum shaping, serial-to-parallel conversion, parallel-to-serial conversion, digital-to-analog conversion, power amplification, low noise amplification, and analog-to-digital conversion, may be further included.
(3) PAPR

A wireless signal, observed in time domain, is a sine wave with a constantly changing amplitude, and the amplitude is not constant. An amplitude peak of the signal in one periodicity is different from that in another periodicity. Therefore, average power and peak power vary with a periodicity. Over a long period of time, the peak power is highest transient power that occurs at a specific probability, where the probability is usually 0.01% (namely, 10\hat{ }−4). A ratio of the peak power at the probability to total average power of a system is the PAPR.
(4) Golay complementary sequence and Golay complementary sequence pair

For two sequences a=(a₀, a₁, a₂, . . . , aₙ₋₁) and b=(b₀, b₁, b₂, . . . , bₙ₋₁) that each have a length of n, it is assumed that:

$${G}_{a} ( j ) = {\sum }_{k = 0}^{n - 1 - j} {a}_{k} {a}_{k + j} .$$

If the sequence a and the sequence b satisfy the following requirement, the sequence a and the sequence b form a Golay complementary sequence pair (or form a pair of Golay complementary sequences), a is a Golay complementary sequence, and b is a Golay complementary sequence.

When 0<j<n−1, Gₐ(j)+G_{b}(j)=0; or when j=0, Gₐ(j)+G_{b}(j)=2n.

In other words, for a Golay complementary sequence pair, when j is not zero, a sum of autocorrelations of two sequences is 0; or when j is zero, a sum of autocorrelation of two sequences is 2n.

It may be understood that, for the sequence a, in addition to the sequence b, there may be another sequence that satisfies the foregoing requirement with the sequence a. For the sequence b, in addition to the sequence a, there may be another sequence that satisfies the foregoing requirement with the sequence b. Therefore, there may be two or more Golay complementary sequences in one Golay complementary sequence pair.

Golay complementary sequences may be classified into a binary Golay complementary sequence, a quaternary Golay complementary sequence, a multi-ary Golay complementary sequence, and the like based on types of elements included in the Golay complementary sequences.
(5) Synchronization signal block (SSB)

The SSB includes a primary synchronization signal (PSS), a secondary synchronization signal (SSS), and a physical broadcast channel (PBCH) signal.

PSS: A signal that a UE first searches for when the UE is powered on and enters a new radio (new radio, NR) system is the PSS. At this stage, the UE searches for a cell at a given carrier frequency. Once the UE detects the PSS, the UE obtains a frequency position of the PSS.

SSS: Once the UE has detected the PSS, the UE also knows transmission timing of the SSS. The UE may determine a physical cell identifier (PCI) of the cell by detecting the SSS.

PBCH: Information carried on the PBCH is a master information block (MIB). The MIB includes a system frame number, a cell barring indication, a system information block (SIB) parameter set, and the like. With these information, the UE obtains other system information broadcast by a network.

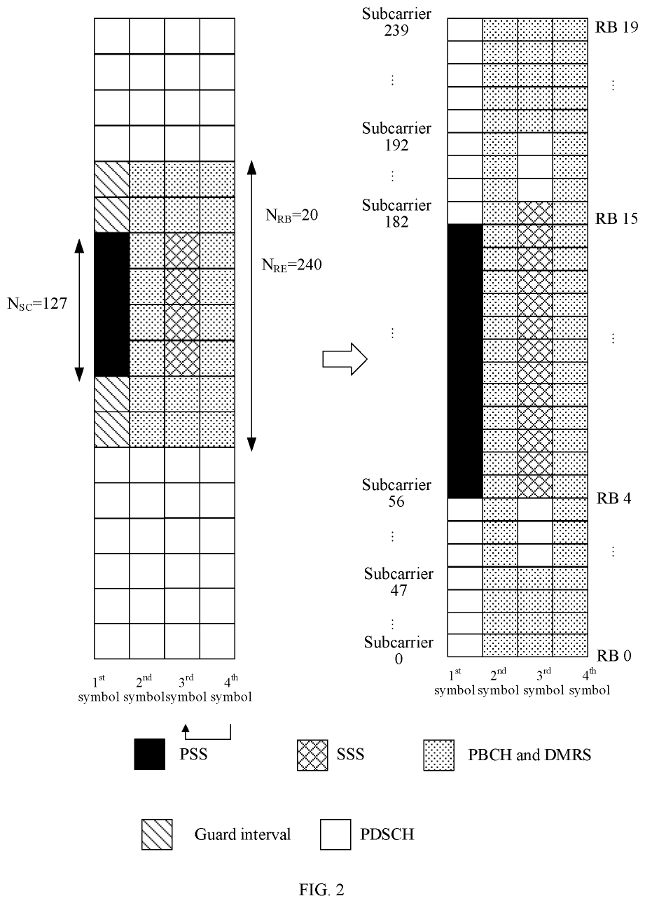

5G SSB frame structure: Each SSB occupies four consecutive symbols in time domain, and occupies 20 RBs (that is, 240 subcarriers) in frequency domain. FIG. 2 is a diagram of a 5G SSB frame structure. A PSS and an SSS respectively occupy 127 subcarriers in a 1^{st} symbol and 127 subcarriers in a 3^{rd} symbol in the SSB, and a PBCH occupies a 2^{nd} symbol and a 4th symbol in the SSB. In addition, the PBCH further occupies 48 subcarriers at each of both ends of the SSS in the 3^{rd} symbol.

Since 5G downlink employs OFDM, that is, a transmission scheme in which signals are placed in frequency domain, a PAPR problem is not considered in 5G SSB design. However, in consideration of evolution of communication systems (for example, 6G), higher frequency bands is used to transmit SSBs. In addition, to further improve coverage, single-carrier transmission may be used in downlink. In this case, requirements on PAPR become more stringent.

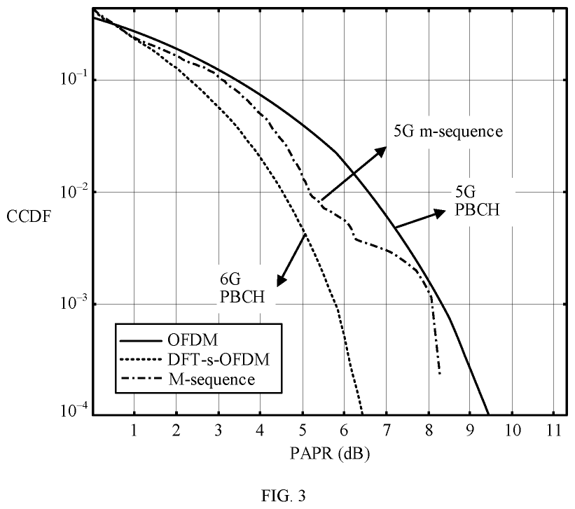

For example, in the 5G system, 3GPP discusses generating a PSS and an SSS by using a maximal-length linear feedback shift register sequence (m-sequence). Refer to FIG. 3. A PAPR of a 5G PSS and SSS (that is, an m-sequence shown in FIG. 3) is lower than that of a 5G PBCH signal, so no performance loss is caused. However, in 6G systems, if a carrier in a higher frequency band is used, and a 6G PBCH signal uses a single downlink carrier, the PAPR of the PSS and SSS (that is, the m-sequence shown in FIG. 3) generated in 5G is higher than that of the PBCH signal. Consequently, power backoff of the system increases, and performance loss is caused.

In view of this, the technical solutions in embodiments of this application are provided, to design a new PSS and/or SSS generation manner, to ensure that a PAPR of the PSS and/or the SSS is lower than that of a PBCH signal, thereby ensuring communication performance.

The technical solutions in embodiments of this application may be applied to various communication systems, for example, a 5th generation (5G) mobile communication system, such as a new radio (NR) system, a 6th generation (6G) mobile communication system, a universal mobile communications system (UMTS), a wireless local area network (WLAN), a wireless fidelity (Wi-Fi) system, and another future evolved communication system.

Embodiments of this application may be applied to the following scenarios: enhanced mobile broadband (eMBB), multi-station transmission (a same terminal device transmits a signal to a plurality of stations), a backhaul scenario, wireless to the x (WTTx), device-to-device (D2D), or another scenario that has a high requirement on timing or a high requirement on a transmission rate.

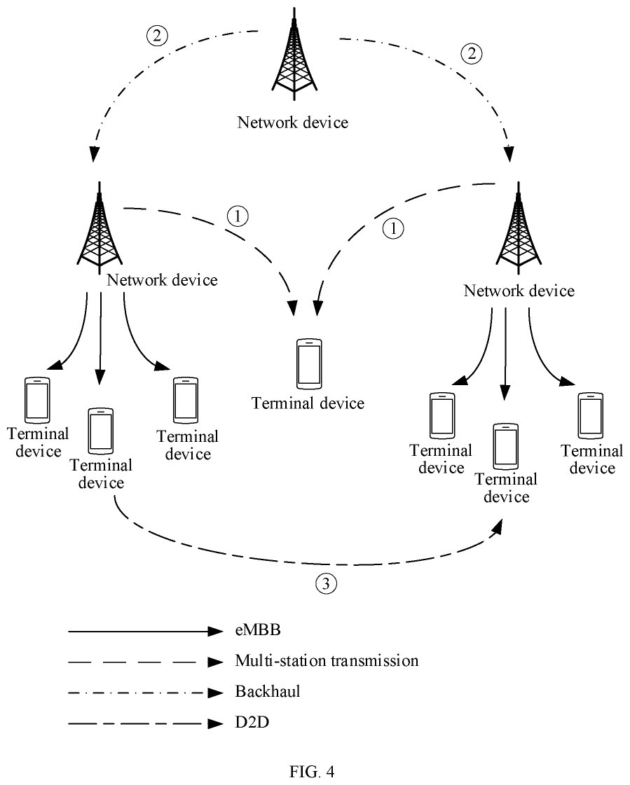

For example, FIG. 4 is a diagram of a communication system to which an embodiment of this application is applicable. As shown in FIG. 4, the communication system may include one or more network devices and one or more terminal devices. An interface between the network device and the terminal device may be a Uu interface (also referred to as an air interface), and data transmission may be performed between the network device and the terminal device by using an air interface resource.

For example, FIG. 4 shows scenarios, to be specific, eMBB (shown by a solid line in FIG. 4), multi-station transmission (shown by a dashed line \textcircled{1} in FIG. 4), a backhaul scenario (shown by a dashed line \textcircled{2} in FIG. 4), and D2D (shown by a dashed line \textcircled{3} in FIG. 4) to which an embodiment of this application is applicable. It should be understood that the four scenarios shown in FIG. 4 are merely examples. This is not limited in embodiments of this application.

The network device may be a base station, an evolved NodeB (eNodeB), a transmission reception point (TRP), a next-generation NodeB (gNB) in a 5th generation (5G) mobile communication system, a base station in a 6th generation (6G) mobile communication system, a base station in a future mobile communication system, an access node in a wireless fidelity (Wi-Fi) system, or the like; or may be a module or a unit that completes a part of functions of the base station, for example, may be a central unit (CU), or may be a distributed unit (DU). An access network device may be a macro base station (for example, 110a in FIG. 4), or may be a micro base station or an indoor base station (for example, 110b in FIG. 4), or may be a relay node, a donor node, or the like. A specific technology and a specific device form that are used by the access network device are not limited in embodiments of this application. In this embodiment of this application, an example in which the base station is used as the access network device is used for description.

In a possible scenario, a plurality of RAN nodes cooperatively assist a terminal in implementing wireless access, and different RAN nodes separately implement a part of functions of the base station. For example, the RAN node may be a central unit (CU), a distributed unit (DU), a CU-control plane (CP), a CU-user plane (UP), a radio unit (RU), or the like. The CU and the DU may be separately arranged, or may be included in a same network element, for example, a baseband unit (BBU). The RU may be included in a radio frequency device or a radio frequency unit, for example, included in a remote radio unit (RRU), an active antenna unit (AAU), or a remote radio head (RRH).

In different systems, the CU (or the CU-CP and the CU-UP), the DU, or the RU may also have different names, but a person skilled in the art may understand meanings thereof. For example, in an open radio access network (open radio access network, ORAN or open RAN or ORAN) system, the CU may also be referred to as an O-CU (open CU), the DU may also be referred to as an O-DU, the CU-CP may also be referred to as an O-CU-CP, the CU-UP may also be referred to as an O-CU-UP, and the RU may also be referred to as an O-RU. For ease of description, the CU, the CU-CP, the CU-UP, the DU, and the RU are used as examples for description in this application. Any one of the CU (or the CU-CP and the CU-UP), the DU, and the RU in this application may be implemented by using a software module, a hardware module, or a combination of the software module and the hardware module.

The terminal device may also be referred to as a terminal, a user equipment (UE), a mobile station, a mobile terminal, or the like. The terminal device may be widely used in various scenarios, for example, device-to-device (D2D), vehicle-to-everything (V2X) communication, machine-type communication (MTC), an internet of things (IoT), virtual reality, augmented reality, industrial control, self-driving, telemedicine, a smart grid, smart furniture, a smart office, a smart wearable, smart transportation, and a smart city. The terminal device may be a mobile phone, a tablet computer, a computer having a wireless transceiver function, a wearable device, a vehicle, an uncrewed aerial vehicle, a helicopter, an airplane, a ship, a robot, a robot arm, a smart home device, or the like. A specific technology and a specific device form that are used by the terminal device are not limited in embodiments of this application.

The base station and the UE may be at fixed positions, or may be movable. The base station and the UE may be deployed on land, including an indoor or outdoor scenario, and a handheld or vehicle-mounted scenario; or may be deployed on water; or may be deployed on an airplane, a balloon, and an artificial satellite in the air. Application scenarios of the base station and the UE are not limited in embodiments of this application.

Communication between a base station and a UE, between base stations, and between UEs may be performed by using a licensed spectrum, or may be performed by using an unlicensed spectrum, or may be performed by using both a licensed spectrum and an unlicensed spectrum. Communication may be performed by using a spectrum below 6 gigahertz (GHz), or may be performed by using a spectrum above 6 GHz, or may be performed by using a spectrum below 6 GHz and a spectrum above 6 GHz. A spectrum resource used for wireless communication is not limited in embodiments of this application.

The communication system and the service scenario described in embodiments of this application are intended to describe the technical solutions in embodiments of this application more clearly, and do not constitute a limitation on the technical solutions provided in embodiments of this application. A person of ordinary skill in the art may learn that, with evolution of a network architecture and emergence of a new scenario, the technical solutions provided in embodiments of this application are also applicable to similar technical problems.

In embodiments of this application, a waveform used for communication between the network device and the terminal device may be a single-carrier waveform, or may be a multi-carrier waveform. In embodiments of this application, a DFT-s-OFDM waveform is used as an example for description.

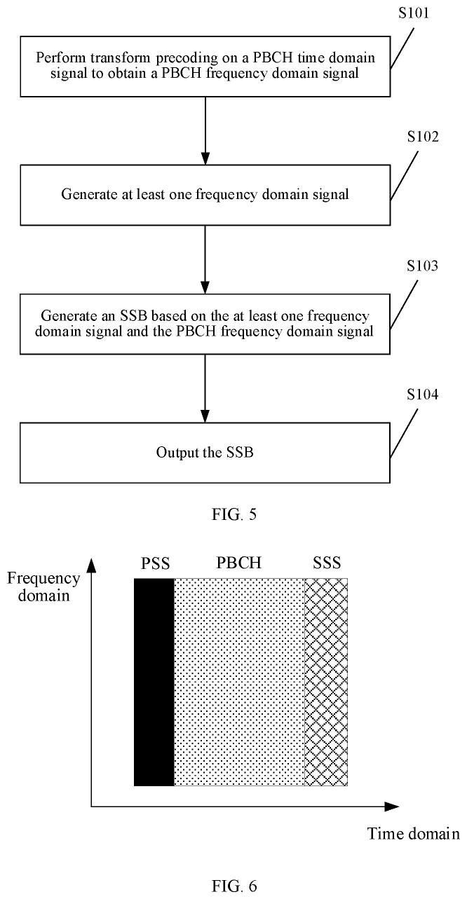

FIG. 5 shows a signal transmission method according to an embodiment of this application. The method may be applied to the communication system shown in FIG. 4. The method may be performed by a first communication device. Unless otherwise specified, the “first communication device” in this application may be the first communication device (for example, the network device or the terminal device shown in FIG. 4), or may be a component (for example, a processor, a chip, or a chip system) in the first communication device, or may be a logical module or software that can implement all or a part of functions of the first communication device. The method includes S101 to S104.

S101: Perform transform precoding on a PBCH time domain signal to obtain a PBCH frequency domain signal.

The PBCH time domain signal is a PBCH signal on which transform precoding is not performed, and the PBCH frequency domain signal is a signal obtained by mapping the PBCH signal to a frequency domain resource. In some embodiments, the PBCH time domain signal and/or the PBCH frequency domain signal may be referred to as PBCH signals/a PBCH signal for short.

Performing transform precoding on the PBCH time domain signal means transforming the PBCH time domain signal from a time domain to a frequency domain. For example, DFT processing is performed on the PBCH time domain signal to obtain the PBCH frequency domain signal.

In this embodiment of this application, the PBCH time domain signal may be transmitted by using a DFT-s-OFDM waveform. For example, refer to a transmitter structure shown in FIG. 1. Transform coding may be performed on the PBCH time domain signal after time domain resource mapping and before subcarrier mapping.

In some embodiments, the PBCH time domain signal may be replaced with another name such as a PBCH time domain sequence or at least one PBCH time domain symbol, and the PBCH frequency domain signal may be replaced with another name such as a PBCH frequency domain sequence or a PBCH frequency domain symbol.

S102: Generate at least one frequency domain signal.

Each of the at least one frequency domain signal is generated based on a Golay complementary sequence. The at least one frequency domain signal may include a PSS and/or an SSS. It may be understood that the frequency domain signal may be replaced with another name such as a frequency domain sequence or a frequency domain symbol. This is not limited.

In a possible implementation, the at least one frequency domain signal is the PSS, in other words, the PSS is generated based on the Golay complementary sequence. The SSS may be generated based on another sequence. For example, the SSS is generated based on a Gold sequence or a zadoff-chu (ZC) sequence. This is not limited in embodiments of this application. In this case, a frame structure of an SSB may be a structure in which the SSS and the PBCH signal overlap in time domain, for example, the frame structure shown in FIG. 3.

In another possible implementation, the at least one frequency domain signal may include the PSS and the SSS, in other words, the PSS and the SSS are generated based on the Golay complementary sequence. The PSS and the SSS may be generated by using a same Golay complementary sequence, or may be generated by using different Golay complementary sequences. This is not limited in embodiments of this application. When the PSS and the SSS are generated by using different Golay complementary sequences, a Golay complementary sequence corresponding to the PSS and a Golay complementary sequence corresponding to the SSS may form a Golay complementary sequence pair, or may not form a Golay complementary sequence pair. This is not limited in embodiments of this application.

In this case, a frame structure of an SSB may be a structure in which the SSS and the PBCH signal do not overlap in time domain. For example, FIG. 6 is a diagram of a possible frame structure of an SSB according to an embodiment of this application. A PSS, an SSS, and a PBCH signal respectively occupy different time domain symbols.

Optionally, the at least one frequency domain signal is a pilot signal (or the at least one frequency domain signal may be used as a pilot signal), and the PSS, the SSS, and the PBCH may be mapped to a same frequency domain resource (or occupy a same bandwidth), as shown in FIG. 6. In this way, the PSS and/or the SSS can be used as primary pilots/a primary pilot (for example, DMRSs/a DMRS) of the PBCH signal, in other words, the PSS and/or the SSS may be used to perform channel estimation on the PBCH signal, so that pilot (for example, DMRS) overheads on the PBCH can be reduced.

It may be understood that the PSS and the SSS need to carry cell identification information respectively corresponding to the PSS and the SSS. For example, the PSS needs to carry a second cell identifier Cell_ID(2), and the SSS needs to carry a first cell identifier Cell_ID(1), or the SSS needs to carry the first cell identifier Cell_ID(1) and the second cell identifier Cell_ID(2).

The following describes several possible design manners in which the PSS and/or the SSS carry/carries the cell identification information.

In a possible design, the first communication device may generate the Golay complementary sequence based on the cell identification information, or the first communication device may include the cell identification information in generation information of the Golay complementary sequence.

For example, the generating the at least one frequency domain signal includes: determining a first Golay complementary sequence based on the cell identification information; and generating a first frequency domain signal based on the first Golay complementary sequence, where the at least one frequency domain signal includes the first frequency domain signal (or the first frequency domain signal is one of the at least one frequency domain signal). The cell identification information is related to a type of the first frequency domain signal, and the type of the first frequency domain signal is PSS or SSS. For example, when the first frequency domain signal is the PSS, the cell identification information is Cell_ID(2); or when the first frequency domain signal is the SSS, the cell identification information is Cell_ID(1), or includes Cell_ID(1) and Cell_ID(2).

The following describes a possible manner of determining the first Golay complementary sequence based on the cell identification information.

First, a first parameter is determined based on the cell identification information.

For ease of description, c_init is used to represent the first parameter in the following.

If the first frequency domain signal is the PSS, c_init is related to Cell_ID(2). If the first frequency domain signal is the SSS, the first parameter c_init is related to Cell_ID(1), or is related to both Cell_ID(1) and Cell_ID(2).

Example 1: If the cell identification information is Cell_ID(2), and the type of the first frequency domain signal is PSS, c_init and Cell_ID(2) may satisfy the following relationship:

c_init=c1*Cell_ID(2).

c1 is related to a maximum cyclic shift length of Cell_ID(2). For example, if c1=43, c_init=43*Cell_ID(2).

Example 2: If the cell identification information is Cell_ID(1), and the type of the first frequency domain signal is SSS, c_init and Cell_ID(1) may satisfy the following relationship:

c_init=Cell_ID(1)mod c2.

c2 is a quantity s1 of candidate values of Cell_ID(1).

For example, if s1=112, c_init=Cell_ID(1) mod 112.

Example 3: If the cell identification information includes Cell_ID(1) and Cell_ID(2), and the type of the first frequency domain signal is SSS, c_init, Cell_ID(1), and Cell_ID(2) may satisfy the following relationship:

c_init=c3*└Cell_ID(1)/c2┘+c4*Cell_ID(2).

c2 is a quantity s1 of candidate values of Cell_ID(1), c3 is a sequence interval step 1 of the SSS, and c4 is a sequence interval step 2 of the SSS. It may be understood that the sequence interval step is used to implement a difference between different SSS sequences. A larger sequence interval step indicates a larger difference between different SSS sequences.

For example, if c2=112, c3=15, and c4=5, c_init=15*└Cell_ID(1)/112┘+5* Cell_ID(2).

Certainly, the foregoing are merely examples of several possible relationships between the cell identification information and c_init, and an actual application is not limited thereto.

Then, a generation function is determined based on the first parameter.

For example, c_init is converted into a binary form as follows:

$${c}_{i n i t}^{2} = d e c 2 b i n ( {c}_{i n i t} ) ,$$

and a binary vector

$${c}_{i n i t}^{2}$$

having a length of N1 is obtained.

x=dec2bin(0:2^{N}^{₁}−1), where x is a binary number matrix of 2^{N}^{₁}*N1.

In this case, the generation function f(x) may be:

$${c}_{init}^{2} ( 0 ) x ( : , 1 ) + {c}_{init}^{2} ( 1 ) x ( : , 2 ) + … + {c}_{init}^{2} ( N 1 ) x ( : , N 1 ) \qquad ( Formula 1 )$$

In Formula 1, c_init may be related to a, b, . . . in the generation function; or may be related to

$${c}_{i n i t}^{2} .$$

In a possible example, an association relationship between c_init and the generation function may be that each binary number is mapped to an addition operation. For example:

$${c}_{i n i t}^{2} ( 0 ) x ( : , 1 ) + {c}_{i n i t}^{2} ( 1 ) x ( : , 2 ) + … + {c}_{i n i t}^{2} ( N 1 ) x ( : , N 1 ) .$$

$${c}_{i n i t}^{2} ( n )$$

represents an n^{th} bit of the binary number

$${c}_{i n i t}^{2} ,$$

and has a value of 0 or 1. x(:,1) is a 1^{st} column of the binary number matrix. Formula 1 means that an n^{th} bit (0 or 1) of an initial value is multiplied by a column vector, and then summed to finally obtain a column vector. The column vector f(x) is used to subsequently generate a Golay complementary sequence. The generated column vector varies with the initial value. In Formula 1, any positional arrangement may be performed. For example,

$${c}_{i n i t}^{2} ( 0 ) x ( : , 2 ) + {c}_{i n i t}^{2} ( 1 ) x ( : , 1 ) + … + {c}_{i n i t}^{2} ( N1 ) x ( : , N 1 ) ,$$

or

$${c}_{i n i t}^{2} ( 0 ) x ( : , N 1 ) + {c}_{i n i t}^{2} ( 1 ) x ( : , 1 ) + … + {c}_{i n i t}^{2} ( N 1 ) x ( : , 2 ) .$$

In another possible example, the association relationship between c_init and the generation function may alternatively be link positions of a, b, and c.

For example, in Formula 1, x(:,1). *x(:,2)+x(:,2). *x(:,3)+ . . . +x(:,N1−1). *x(:,N1) forms a link formula from 1 to N1 (from 1 to 2, 2 to 3, . . . , and (N1−1) to N1). Certainly, a start point and an end point of the link can be adjusted arbitrarily, provided that link points cover all values from 1 to N1. For example, x(:,2).*x(:,1)+x(:,1).*x(:,3)+ . . . +x(:,N1−1).*x(:,N1) forms a link formula from 2 to N1 (from 2 to 1, 1 to 3, . . . , and (N1−1) to N1). c_init may be reflected in this link formula. For example, c_init=1 indicates a link from 1 to N1, c_init=2 indicates a link from 3 to N1, and so on.

Finally, the first Golay complementary sequence is obtained based on the generation function f(x).

For example, a Golay complementary sequence pair is obtained based on the generation function f(x). A Golay complementary sequence pair including two Golay complementary sequences that each have a length of 2^{N}^{₁} is used as an example:

r(2n)=(−1)·\hat{ }f(x); and

r(2n+1)=(−1)·\hat{ }f(x)+x(:,1).

In this case, the first Golay complementary sequence may be r(2n) or r(2n+1).

In another possible design, the Golay complementary sequence used to generate the at least one frequency domain signal may be at least one fixed Golay complementary sequence (where for example, the at least one Golay complementary sequence may be specified in a protocol, or preconfigured in a system, and this is not limited). The first communication device may indicate the cell identification information by performing a cyclic shift on the Golay complementary sequence.

For example, a cyclic shift may be performed on a second Golay complementary sequence based on the cell identification information, and a second frequency domain signal is generated based on a second Golay complementary sequence obtained through the cyclic shift, where the at least one frequency domain signal includes the second frequency domain signal (or the second frequency domain signal is one of the at least one frequency domain signal).

The cell identification information is related to a type of the second frequency domain signal, and the type of the second frequency domain signal is PSS or SSS. For example, when the second frequency domain signal is the PSS, the cell identification information is Cell_ID(2); or when the second frequency domain signal is the SSS, the cell identification information is Cell_ID(1), or includes Cell_ID(1) and Cell_ID(2).

A cyclic shift length is related to a value of the cell identification information.

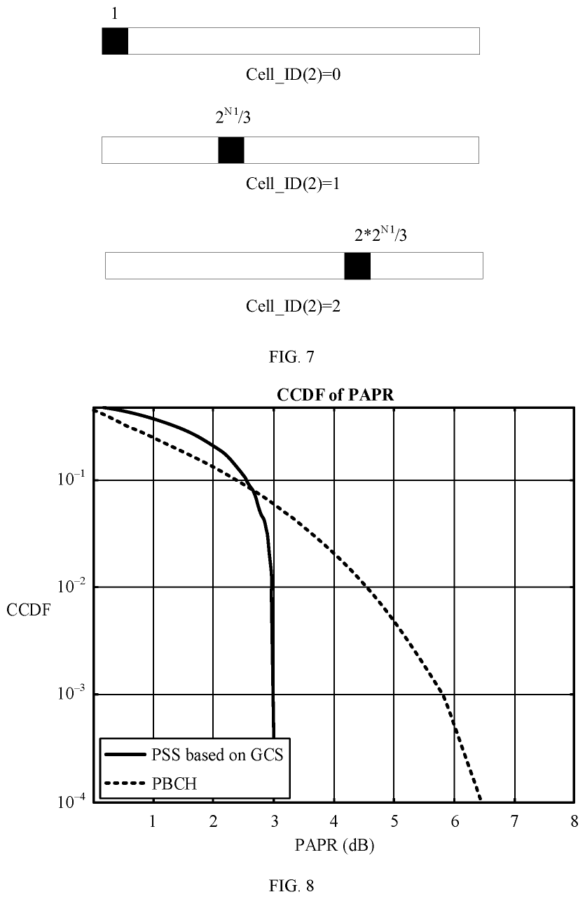

The PSS is used as an example. There are three possible values of Cell_ID(2), that is, 0, 1, and 2. In this case, 0, 1, and 2 may be respectively indicated by using different cyclic shift lengths. For example, as shown in FIG. 7, when Cell_ID(2)-0, the cyclic shift length is 1; when Cell_ID (2)=1, the cyclic shift length is 2^{N}^{₁}/3, and the cyclic shift length is 0; or when Cell_ID(2)-3, the cyclic shift length is 2*2^{N}^{₁}/3, where 2^{N}^{₁} represents a length of the Golay complementary sequence. Certainly, FIG. 7 is merely an example, and an actual correspondence between the cyclic shift length and a value of Cell_ID(2) is not limited thereto. For the SSS, refer to an example of the PSS. No example is provided herein again.

It may be understood that the foregoing merely lists two manners of carrying the cell identification information, and an actual application is not limited thereto.

In some embodiments, if the length of the Golay complementary sequence generated in the foregoing manner is not equal to a target length (for example, the Golay complementary sequence used to generate the PSS has a length different from a length of the PSS, and the Golay complementary sequence used to generate the SSS has a length different from a length of the SSS), the Golay complementary sequence may be further extended (or expanded, processed, or the like) to the target length. An extension manner may be lengthening or shortening. This is not limited.

A scenario in which the PSS and/or the SSS and the PBCH signal occupy a same bandwidth is used as an example (in other words, the target length is equal to the length of the PBCH, and is represented by N). If the length of the Golay complementary sequence is different from a length of the PBCH frequency domain signal, the Golay complementary sequence needs to be extended to a length that is the same as the length of the PBCH frequency domain signal.

For example, the generating the at least one frequency domain signal may further include: extending a third Golay complementary sequence to obtain a third frequency domain signal, where the at least one frequency domain signal includes the third frequency domain signal (or the third frequency domain signal is one of the at least one frequency domain signal), and a length to which the third Golay complementary sequence is extended is related to the length of the PBCH frequency domain signal.

The following describes two possible extension manners.

Manner 1: If N≠2^{N}^{₁}, and N=2^{N}^{₁}*c^{N}^{₂}, where N2 is a positive integer, the Golay complementary sequence may be extended N2 times by using the following formula.

A Golay complementary sequence pair of r(2n) and r(2n+1) is used as an example:

r′(2n)=a⊙(r(2n)+r(2n+1))/2+b⊙(r(2n)−r(2n+1))/2; and

r′(2n+1)=a⊙(r(2n)+r(2n+1))/2−b⊙(r(2n)−r(2n+1))/2.

r′⁽²ⁿ⁾ and r′ (2n+1) are an extended Golay complementary sequence pair, and represents convolution; and [a, b] is a Golay complementary sequence pair having a length of c.

Manner 2: If N≠2^{N}^{₁}, and N≠2^{N}^{₁}*c^{N}^{₂}, where N2 is a positive integer, the Golay complementary sequence may be directly padded or truncated to the length that is the same as that of the PBCH frequency domain signal. For example:

$${\overline{r}}^{′} = \overline{r} ( \frac{3 N}{2} - \frac{M}{2} : N - 1 ) \overline{r} \overline{r} ( 0 : \frac{M}{2} - \frac{N}{2} - 1 ) ] .$$

r̅ is a sequence generated in the foregoing steps. For example, r=r(2n). r̅′ is extension of the sequence, N is a sequence length of r̅, and M is a total length of the extended sequence.

It may be understood that the foregoing extension manners are merely examples, and an actual application is not limited thereto.

Further, after the Golay complementary sequence is obtained, the at least one frequency domain signal is generated based on the Golay complementary sequence.

For example, an example in which a PSS sequence is generated based on the Golay complementary sequence is used:

d(n)=1−2×(m); or d(n)=x(m); where

m=(n+c_init)mod Length_Sequence.

d(n) is the PSS sequence; n is an index of d(n), and represents an n^{th} sequence of d(n); m is an index of a correlation sequence x(m), and represents an m^{th} sequence of x(m); m and n are related to an initial value; x is a base sequence, that is, the Golay complementary sequence obtained above; and Length_Sequence is a length of the PSS sequence.

S103: Generate an SSB based on the at least one frequency domain signal and the PBCH frequency domain signal.

The at least one frequency domain signal and the PBCH frequency domain signal occupy different symbols. It may be understood that the symbol herein is a time domain symbol, for example, an OFDM symbol. This is not limited in this application.

For example, if the at least one frequency domain signal includes the PSS, the PSS and the PBCH frequency domain signal occupy different symbols. Optionally, the PSS and the PBCH frequency domain signal may occupy a same bandwidth (in other words, the PSS and the PBCH frequency domain signal are mapped to a same frequency domain resource), for example, as shown in FIG. 6. In this way, the PSS may be used as a primary pilot of the PBCH frequency domain signal.

For example, if the at least one frequency domain signal includes the PSS and the SSS, the PSS, the SSS, and the PBCH frequency domain signal occupy different symbols. Optionally, the PSS, the SSS, and the PBCH frequency domain signal may occupy a same bandwidth (in other words, the PSS, the SSS, and the PBCH frequency domain signal are mapped to a same frequency domain resource), for example, as shown in FIG. 6. In this way, both the PSS and the SSS may be used as primary pilots of the PBCH frequency domain signal.

In a specific implementation, the generating the SSB based on the at least one frequency domain signal and the PBCH frequency domain signal may specifically include: combining (or splicing) the at least one frequency domain signal and the PBCH frequency domain signal into an SSB, to obtain a frequency domain SSB. An example in which the at least one frequency domain signal includes the PSS and the SSS is used. The generating the SSB based on the at least one frequency domain signal and the PBCH frequency domain signal may include: adding the PSS and the SSS around the PBCH frequency domain signal.

It may be understood that the generated SSB herein may be an SSB (namely, a frequency domain SSB) obtained through frequency domain resource mapping (or subcarrier mapping), or may be an SSB (a time domain SSB) obtained through processing such as IFFT and CP addition. This is not limited in this application. Optionally, the generating the SSB may further include: performing operations such as IFFT and CP addition on the frequency domain SSB to obtain the time domain SSB.

S104: Output the SSB.

It may be understood that the outputting the SSB may be outputting the SSB to a processing unit (for example, intermediate frequency), or may be sending the SSB by using a carrier. This is not limited in embodiments of this application.

In the foregoing solution, the at least one frequency domain signal (such as the PSS or the SSS) in the SSB is generated based on the Golay complementary sequence, so that a PAPR of the at least one frequency domain signal in the SSB can be improved. For example, the PAPR of the at least one frequency domain signal in the SSB is lower than a PAPR of the PBCH signal in the SSB. In this way, system performance is improved. In addition, in this embodiment of this application, it is further designed that the PSS (and/or the SSS) and the PBCH signal occupy a same bandwidth, so that the PSS (and/or the SSS) can be used as a primary pilot for channel estimation of the PBCH signal. The Golay complementary sequence has both a low PAPR and frequency domain flatness. This further helps improve channel estimation quality of the PBCH signal, and pilot overheads of the PBCH signal can be reduced.

For example, FIG. 8 is a diagram of a set of experimental data based on the foregoing solution according to an embodiment of this application. In FIG. 8, a horizontal coordinate indicates a PAPR (dB), and represents a peak power ratio of a signal, and a vertical coordinate indicates a complementary cumulative distribution function (CCDF), and represents a probability that the peak power ratio of the signal is greater than a value on the horizontal coordinate. It can be learned from FIG. 8 that, in a portion in which the PAPR is greater than 3 dB, a PAPR of a PSS generated based on the foregoing solution is lower than a PAPR of a PBCH signal.

The foregoing describes a signal transmission method on a first communication device side, and the following describes a signal transmission method on a second communication device side.

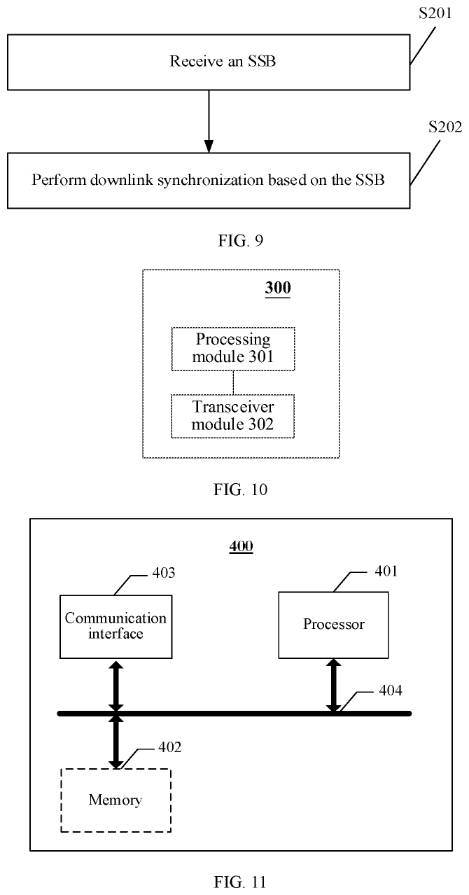

Refer to FIG. 9. An embodiment of this application further provides a signal transmission method. The method may be performed by a second communication device. Unless otherwise specified, the “second communication device” in this application may be the second communication device (for example, the network device or the terminal device shown in FIG. 4), or may be a component (for example, a processor, a chip, or a chip system) in the second communication device, or may be a logical module or software that can implement all or a part of functions of the second communication device. The method includes S201 and S202.

S201: Receive an SSB.

The SSB includes at least one frequency domain signal and a PBCH frequency domain signal, and each of the at least one frequency domain signal is generated based on a Golay complementary sequence. For detailed descriptions of the SSB, the at least one frequency domain signal, the PBCH frequency domain signal, the Golay complementary sequence, and the like, refer to the foregoing related content. Details are not described herein again.

S202: Perform downlink synchronization based on the SSB.

For example, S202 may include the following steps.
(1) Synchronization is performed on a PSS in the SSB.

For example, first, P Golay complementary sequences are determined based on P candidate values of a second cell identifier Cell_ID(2), where P is a positive integer, and a candidate value of Cell_ID(2) is a possible value of Cell_ID(2). For example, if possible values are 0, 1, and 2, three Golay complementary sequences are respectively generated based on 0, 1, and 2 (where for details, refer to the foregoing manner in which the first communication device generates the Golay complementary sequence based on Cell_ID(2)).

Then, a peak search is performed on the PSS in the SSB based on the P Golay complementary sequences, to determine a maximum peak value. A Golay complementary sequence corresponding to the maximum peak value is a Golay complementary sequence used by a first terminal device to generate the PSS.

Finally, timing information and frequency offset information of the PSS are determined based on the found maximum peak value, synchronization processing is performed on the PSS based on the timing information and the frequency offset information of the PSS, and the second cell identifier Cell_ID(2) is determined based on the Golay complementary sequence corresponding to the found maximum peak value.
(2) Synchronization is performed on an SSS after Cell_ID(2) is parsed.

For example, first, the timing information and the frequency offset information of the PSS are used as approximate timing information and frequency offset information of the SSS, and a first time of synchronization processing is performed on the SSS in the SSB based on the timing information and the frequency offset information of the PSS.

Then, Q Golay complementary sequences are determined based on Q candidate values of a first cell identifier Cell_ID(1), where Q is a positive integer, and a candidate value of Cell_ID(1) is a possible value of Cell_ID(1).

Then, a peak search is performed, based on the Q Golay complementary sequences, on an SSS obtained through the first time of synchronization processing. Because there are a large quantity of candidate values of Cell_ID(1), a maximum peak value may be determined in a blind search and matching manner(for example, through a sliding correlation) herein. A Golay complementary sequence corresponding to the maximum peak value is a Golay complementary sequence used by the first terminal device to generate the SSS.

Finally, timing information and frequency offset information of the SSS are determined based on the found maximum peak value, a second time of synchronization processing is performed on the SSS based on the timing information and the frequency offset information of the SSS, and the first cell identifier Cell_ID(1) is determined based on the Golay complementary sequence corresponding to the found maximum peak value.
(3) If bandwidths/a bandwidth occupied by the PSS and/or the SSS are/is the same as a bandwidth occupied by the PBCH frequency domain signal (or the PSS and/or the SSS and the PBCH frequency domain signal are mapped to a same frequency domain resource), channel estimation may be performed on the PBCH frequency domain signal by using the PSS and/or the SSS, to obtain channel estimation performance of the PBCH frequency domain signal, perform channel equalization on the PBCH frequency domain signal, and demodulate system information carried in the PBCH frequency domain signal. If the PSS and/or the SSS and the PBCH frequency domain signal occupy different bandwidths (or are mapped to different frequency domain resources), signal estimation may be performed on the PBCH frequency domain signal by using a DMRS configured for the PBCH frequency domain signal, to obtain channel estimation performance of the PBCH frequency domain signal, perform channel equalization on the PBCH frequency domain signal, and demodulate system information carried in the PBCH frequency domain signal.

In the foregoing solution, because the at least one frequency domain signal (such as the PSS or the SSS) in the SSB received by the second communication device is generated based on a Golay complementary sequence pair, a PAPR of the at least one frequency domain signal in the SSB can be improved. For example, the PAPR of the at least one frequency domain signal in the SSB is lower than a PAPR of the PBCH signal in the SSB. In this way, system performance is improved. In addition, when the bandwidths/bandwidth occupied by the PSS and/or the SSS are/is the same as the bandwidth occupied by the PBCH signal, the PSS and/or the SSS may be further used as primary pilots/a primary pilot for channel estimation of the PBCH signal. The Golay complementary sequence has both a low PAPR and frequency domain flatness. This further helps improve channel estimation quality of the PBCH signal, and pilot overheads of the PBCH signal can be further reduced.

The methods provided in embodiments of this application are described above with reference to the accompanying drawings. The following describes apparatuses provided in embodiments of this application with reference to the accompanying drawings.

Based on a same technical concept, an embodiment of this application provides a communication apparatus 300. The apparatus 300 may be, for example, a satellite, a base station, a terminal, an access point, or a chip inside the satellite, the base station, the terminal, or the access point. The apparatus 300 includes corresponding modules, units, or means for performing the method steps in the foregoing method embodiments. The functions, units, or means may be implemented by software, may be implemented by hardware, or may be implemented by hardware executing corresponding software.

For example, refer to FIG. 10. The apparatus 300 may include a processing module 301 and a transceiver module 302.

When the apparatus 300 is located in a first communication device,
the processing module 301 performs transform precoding on a PBCH time domain signal to obtain a PBCH frequency domain signal; generates at least one frequency domain signal, where each of the at least one frequency domain signal is generated based on a Golay complementary sequence; and generates a synchronization signal block SSB based on the at least one frequency domain signal and the PBCH frequency domain signal, where the at least one frequency domain signal and the PBCH frequency domain signal occupy different symbols; and
the transceiver module 302 is configured to output the SSB.

When the apparatus 300 is located in a second communication device,
the transceiver module 302 receives an SSB, where the SSB includes at least one frequency domain signal and a PBCH frequency domain signal, and each of the at least one frequency domain signal is generated based on a Golay complementary sequence; and
the processing module 301 performs downlink synchronization based on the SSB.

It should be understood that all related content of the steps in the foregoing method embodiment may be cited in function descriptions of corresponding functional modules. Details are not described herein again.

Refer to FIG. 11. An embodiment of this application further provides a communication apparatus 400, including:
at least one processor 401, and a communication interface 403 communicatively connected to the at least one processor 401, where the at least one processor 401 executes instructions stored in a memory 402, so that the apparatus performs the method steps in the foregoing method embodiments through the communication interface 403.

Optionally, the memory 402 is located outside the apparatus 400.

Optionally, the apparatus 400 includes the memory 402. The memory 402 is connected to the at least one processor 401, and the memory 402 stores the instructions that can be executed by the at least one processor 401. In FIG. 11, a dashed line indicates that the memory 402 is optional for the apparatus 400.

The processor 401 and the memory 402 may be coupled through an interface circuit, or may be integrated together. This is not limited herein.

A specific connection medium between the processor 401, the memory 402, and the communication interface 403 is not limited in embodiments of this application. In this embodiment of this application, the processor 401, the memory 402, and the communication interface 403 are connected through a bus 404 in FIG. 11. The bus is represented by a bold line in FIG. 11. A connection manner between other components is merely an example for description, and is not limited thereto. The buses may be classified into an address bus, a data bus, a control bus, and the like. For ease of representation, only one bold line is used to represent the bus in FIG. 11, but this does not mean that there is only one bus or only one type of bus.

A specific connection medium between the processor 401, the memory 402, and the communication interface 403 is not limited in embodiments of this application. In this embodiment of this application, the processor 401, the memory 402, and the communication interface 403 are connected through a bus 404 in FIG. 11. The bus is represented by a bold line in FIG. 11. A connection manner between other components is merely an example for description, and is not limited thereto. The buses may be classified into an address bus, a data bus, a control bus, and the like. For ease of representation, only one bold line is used to represent the bus in FIG. 11, but this does not mean that there is only one bus or only one type of bus.

It should be understood that the processor mentioned in embodiments of this application may be implemented by hardware or by software. When the processor is implemented by the hardware, the processor may be a logic circuit, an integrated circuit, or the like. When the processor is implemented by the software, the processor may be a general-purpose processor, and is implemented by reading software code stored in the memory.

For example, the processor may be a central processing unit (CPU), or may be another general-purpose processor, a digital signal processor(DSP), an application-specific integrated circuit (ASIC), a field programmable gate array (FPGA), or another programmable logic device, discrete gate or transistor logic device, discrete hardware component, or the like. The general-purpose processor may be a microprocessor, or the processor may be any conventional processor or the like.

It should be understood that the memory mentioned in embodiments of this application may be a volatile memory or a nonvolatile memory, or may include both a volatile memory and a nonvolatile memory. The nonvolatile memory may be a read-only memory (ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (RAM), used as an external cache. By way of example and not limitation, RAMs in many forms may be used, for example, a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDR SDRAM), an enhanced synchronous dynamic random access memory (Enhanced SDRAM, ESDRAM), a synchlink dynamic random access memory (Synchlink DRAM, SLDRAM), and a direct rambus random access memory (Direct Rambus RAM, DR RAM).

It should be noted that when the processor is a general-purpose processor, a DSP, an ASIC, an FPGA or another programmable logic device, a discrete gate or a transistor logic device, or a discrete hardware component, a memory (storage module) may be integrated into the processor.

It should be noted that the memory described in this specification aims to include but is not limited to these memories and any memory of another proper type.

Based on a same technical concept, an embodiment of this application further provides a computer-readable storage medium, including a program or instructions. When the program or the instructions are run on a computer, the method in the foregoing method embodiments is performed.

Based on a same technical concept, an embodiment of this application further provides a computer program product, including instructions. When the instructions are run on a computer, the method in the foregoing method embodiments is performed.

A person skilled in the art should understand that embodiments of this application may be provided as a method, a system, or a computer program product. Therefore, this application may use a form of hardware only embodiments, software only embodiments, or embodiments with a combination of software and hardware. In addition, this application may use a form of a computer program product that is implemented on one or more computer-usable storage media (including but not limited to a disk memory, a CD-ROM, an optical memory, and the like) that include computer-usable program code.

This application is described with reference to the flowcharts and/or block diagrams of the method, the device (system), and the computer program product according to this application. It should be understood that computer program instructions may be used to implement each process and/or each block in the flowcharts and/or the block diagrams and a combination of a process and/or a block in the flowcharts and/or the block diagrams. These computer program instructions may be provided for a general-purpose computer, a dedicated computer, an embedded processor, or a processor of any other programmable data processing device to generate a machine, so that the instructions executed by a computer or a processor of any other programmable data processing device generate an apparatus for implementing a specific function in one or more processes in the flowcharts and/or in one or more blocks in the block diagrams.

These computer program instructions may be stored in a computer-readable memory that can instruct the computer or any other programmable data processing device to work in a specific manner, so that the instructions stored in the computer-readable memory generate an artifact that includes an instruction apparatus. The instruction apparatus implements a specific function in one or more processes in the flowcharts and/or in one or more blocks in the block diagrams.

The computer program instructions may alternatively be loaded onto a computer or another programmable data processing device, so that a series of operations and steps are performed on the computer or the another programmable device, so that computer-implemented processing is generated. Therefore, the instructions executed on the computer or the another programmable device provide steps for implementing a specific function in one or more procedures in the flowcharts and/or in one or more blocks in the block diagrams.

1. A signal transmission method, comprising:
performing transform precoding on a physical broadcast channel (PBCH) time domain signal to obtain a PBCH frequency domain signal;
generating at least one frequency domain signal, based on a Golay complementary sequence (GCS);
generating a synchronization signal block (SSB) based on the at least one frequency domain signal and the PBCH frequency domain signal, wherein the at least one frequency domain signal and the PBCH frequency domain signal occupy different symbols; and
outputting the SSB.

2. The method according to claim 1, wherein the at least one frequency domain signal comprises one or more of: a primary synchronization signal (PSS) or a secondary synchronization signal (SSS).

3. The method according to claim 1, wherein the generating the at least one frequency domain signal comprises:
determining a first GCS based on cell identification information; and
generating a first frequency domain signal based on the first GCS, wherein the at least one frequency domain signal comprises the first frequency domain signal,
the cell identification information is related to a type of the first frequency domain signal, and the type of the first frequency domain signal is PSS or SSS.

4. The method according to claim 3, wherein the determining the first GCS based on the cell identification information comprises:
determining a first parameter based on the cell identification information; and
determining the first GCS based on the first parameter, wherein the first GCS is a function of the first parameter.

5. The method according to claim 3, wherein the cell identification information is determined based on a second cell identifier Cell_ID(2), and the type of the first frequency domain signal is PSS,
the first parameter and the second cell identifier Cell_ID(2) satisfy:
c_init=c1*Cell_ID(2),
wherein c_init represents the first parameter, c1 is related to a quantity of candidate values of cell identifiers Cell_ID and a quantity of candidate values of the second cell identifier Cell_ID(2), and the cell identifiers comprise the second cell identifier Cell_ID(2) and a first cell identifier Cell_ID(1).

6. The method according to claim 3, wherein the cell identification information is determined based on the first cell identifier Cell_ID(1), and the type of the first frequency domain signal is SSS,
the first parameter and the first cell identifier Cell_ID(1) satisfy the following relationship:
c_init=Cell_ID(1)mod c2, wherein
c_init represents the first parameter, and c2 is a quantity of candidate values of the first cell identifier Cell_ID(1).

7. The method according to claim 3, wherein the cell identification information is determined based on the first cell identifier Cell_ID(1) and the second cell identifier Cell_ID(2), and the type of the first frequency domain signal is SSS,
the first parameter, the first cell identifier Cell_ID(1), and the second cell identifier Cell_ID(2) satisfy the following relationship:
c_init=c3*└Cell_ID(1)/c2┘+c4*Cell_ID(2), wherein
c_init represents the first parameter, c2 is a quantity of candidate values of the first cell identifier Cell_ID(1), c3 is a sequence interval step 1 of the SSS, and c4 is a sequence interval step 2 of the SSS.

8. The method according to claim 1, wherein the generating the at least one frequency domain signal comprises:
performing a cyclic shift on a second GCS based on the cell identification information; and
generating a second frequency domain signal based on a second GCS obtained through the cyclic shift, wherein the at least one frequency domain signal comprises the second frequency domain signal.

9. The method according to claim 8, wherein the relationship between cell identification information and cell identifier is one of the following:
the cell identification information is determined based on a second cell identifier Cell_ID(2), and the second frequency domain signal is a PSS;
the cell identification information is determined based on a first cell identifier Cell_ID(1), and the second frequency domain signal is an SSS; or
the cell identification information is determined based on the first cell identifier Cell_ID(1) and the second cell identifier Cell_ID(2), and the second frequency domain signal is an SSS.

10. A signal transmission method, comprising:
receiving a synchronization signal block (SSB), wherein the SSB comprises at least one frequency domain signal and a physical broadcast channel (PBCH) frequency domain signal, and each of the at least one frequency domain signal is generated based on a Golay complementary sequence (GCS); and
performing downlink synchronization based on the SSB.

11. The method according to claim 10, wherein the at least one frequency domain signal comprises one or more of: a primary synchronization signal (PSS) or a secondary synchronization signal (SSS).

12. The method according to claim 11, wherein the performing downlink synchronization based on the SSB comprises:
determining P GCSs based on P candidate values of a second cell identifier Cell_ID(2), wherein P is a positive integer;
performing a peak search on the PSS in the SSB based on the P GCSs; and
determining timing information and frequency offset information of the PSS based on a found maximum peak value, performing synchronization processing on the PSS based on the timing information and the frequency offset information of the PSS, and determining the second cell identifier Cell_ID(2) based on a GCS corresponding to the found maximum peak value.

13. The method according to claim 12, wherein the performing downlink synchronization based on the SSB further comprises:
performing a first time of synchronization processing on the SSS in the SSB based on the timing information and the frequency offset information of the PSS;
determining Q GCSs based on Q candidate values of a first cell identifier Cell_ID(1), wherein Q is a positive integer, and performing, based on the Q GCSs, a peak search on an SSS obtained through the first time of synchronization processing; and
determining timing information and frequency offset information of the SSS based on a found maximum peak value, performing a second time of synchronization processing on the SSS based on the timing information and the frequency offset information of the SSS, and determining the first cell identifier Cell_ID(1) based on a GCS corresponding to the found maximum peak value.

14. A communication apparatus, comprises: at least one processor, wherein the at least one processor is configured to implement the apparatus:
perform transform precoding on a physical broadcast channel (PBCH) time domain signal to obtain a PBCH frequency domain signal;
generate at least one frequency domain signal based on a Golay complementary sequence (GCS);
generate a synchronization signal block (SSB) based on the at least one frequency domain signal and the PBCH frequency domain signal, wherein the at least one frequency domain signal and the PBCH frequency domain signal occupy different symbols; and
output the SSB.

15. The communication apparatus according to claim 14, wherein the at least one frequency domain signal comprises one or more of: a primary synchronization signal (PSS) or a secondary synchronization signal (SSS).

16. The communication apparatus according to claim 15, wherein the communication apparatus is further configured to:
determine a first parameter based on the cell identification information; and
determine the first GCS based on the first parameter, wherein the first GCS is a function of the first parameter.

17. The communication apparatus according to claim 15, wherein the cell identification information is determined based on a second cell identifier Cell_ID(2), and the type of the first frequency domain signal is PSS,
the first parameter and the second cell identifier Cell_ID(2) satisfy the following relationship:
c_init=c1*Cell_ID(2), wherein
c_init represents the first parameter, c1 is related to a quantity of candidate values of cell identifiers Cell_ID and a quantity of candidate values of the second cell identifier Cell_ID(2), and the cell identifiers comprise the second cell identifier Cell_ID(2) and a first cell identifier Cell_ID(1).

18. The communication apparatus according to claim 15, wherein the cell identification information is determined based on the first cell identifier Cell_ID(1), and the type of the first frequency domain signal is SSS,
the first parameter and the first cell identifier Cell_ID(1) satisfy the following relationship:
c_init=Cell_ID(1)mod c2, wherein
c_init represents the first parameter, and c2 is a quantity of candidate values of the first cell identifier Cell_ID(1).

19. The communication apparatus according to claim 15, wherein the cell identification information is determined based on the first cell identifier Cell_ID(1) and the second cell identifier Cell_ID(2), and the type of the first frequency domain signal is SSS,
the first parameter, the first cell identifier Cell_ID(1), and the second cell identifier Cell_ID(2) satisfy the following relationship:
c_init=c3*└Cell_ID(1)/c2┘+c4*Cell_ID(2), wherein
c_init represents the first parameter, c2 is a quantity of candidate values of the first cell identifier Cell_ID(1), c3 is a sequence interval step 1 of the SSS, and c4 is a sequence interval step 2 of the SSS.

20. The communication apparatus according to claim 14, wherein the communication apparatus is further configured to:
perform a cyclic shift on a second GCS based on the cell identification information; and
generate a second frequency domain signal based on a second GCS obtained through the cyclic shift, wherein the at least one frequency domain signal comprises the second frequency domain signal.
